(19) United States
(12) Patent Application Publication
(10) Pub. No.: US 2010/0024618 A1
(43) Pub. Date: Feb. 4, 2010

(54) DUST COLLECTING MECHANISM AND SUBSTRATE CUTTING APPARATUS INCLUDING THE SAME

(75) Inventors: Gen Minemura, Kamiminochi (JP); Koji Yamakami, Kamiminochi (JP); Tadashi Inoue, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/496,018

(22) Filed: Jul. 1, 2009

(30) Foreign Application Priority Data
Jul. 31, 2008 (JP) 2008-198157

(51) Int. Cl. B26D 7/18; A47L 5/38

(52) U.S. Cl. 83/168; 15/301; 15/303

(57) ABSTRACT

A dust collecting mechanism is a dust collecting mechanism that sucks up and collects dust generated by a machining apparatus, including a suction section for sucking up the dust by exerting sucking force on a workpiece, a sucking force generating mechanism for generating sucking force acting on the suction section, and a suction pipe enabling communication between the suction section and the sucking force generating mechanism, wherein the suction pipe includes an opening section extending from the inside to the outside thereof and a shutter mechanism for opening and closing the opening section, and wherein the pressure inside the suction pipe can be switched between an atmospheric pressure state and a sucking force generating state by causing the shutter mechanism to open or close the opening section while sucking force is generated inside the suction pipe by operating the sucking force generating mechanism.

### CROSS-REFERENCE TO RELATED APPLICATIONS

This application is based upon and claims the benefit of priority of the prior Japanese Patent Application No. 2008-198157, filed on Jul. 31, 2008, the entire contents of which are incorporated herein by reference.

### FIELD

The embodiment discussed herein is related to a dust collecting mechanism and a substrate cutting apparatus and, more particularly, to a dust collecting mechanism for sucking up and collecting dust generated by a machining apparatus and to a substrate cutting apparatus provided with the dust collecting mechanism.

### BACKGROUND

A printed substrate cutting apparatus for cutting a composite printed substrate mounted with predetermined electronic components into a plurality of printed substrates is well known.

A printed substrate cutting apparatus generally secures a composite printed substrate thereto and cuts it along predetermined cutting lines by using a cutter or the like into printed substrates. The cutting dust generated at the time of cutting is removed from on and around the printed substrate by a sucking force or the like generated by a sucking apparatus.

A conventional substrate cutting apparatus 50 is illustrated in FIG. 6. The substrate cutting apparatus 50 cuts a planar printed substrate (hereinafter referred to as “substrate”) 2 removably mounted on a fixed unit 9 along predetermined cutting lines with a cutter (router bit) 3 provided thereon so as to be arbitrarily movable in a plane substantially parallel to a workpiece or a substrate 2 and having a blade formed at the edge of a rotating shaft thereof. The substrate cutting apparatus 50 is provided with a dust collecting mechanism 4 for sucking up and collecting the dust (cutting dust) generated on and around the cutting line in the substrate 2. Typically, the substrate 2 is placed on a pallet (not illustrated) and removably mounted on the fixed unit 9 together with the pallet.

The dust collecting mechanism 4 includes a main body 5 having a suction fan (not illustrated) incorporated therein as a sucking force generating mechanism, a tubular suction pipe 7 connected at one end to the main body 5 and provided at the other end with a suction section (a funnel-like duct collection nozzle) 6, and a dust collecting tray 10 for storing the collected dust. The suction section 6 is installed on the back side (opposed to the mounting surface of the substrate 2) of the fixed unit 9.

While a substrate 2 is being cut, dust 8 generated by the cutting is sucked with the activated fan into the suction section 6 through dust discharge holes 9a provided in the fixed unit 9, and sent to the main body 5 through the suction pipe 7. Then the dust 8 is trapped with a filter or the like (not illustrated) before being collected and stored in a dust collection tray 10.

However, in the conventional substrate cutting apparatus 50 having the above structure, a substrate 2 (a pallet having a substrate 2 placed thereon in this case) having been subjected to the cutting process cannot be removed from the fixed unit 9 unless the sucking force being exerted on the substrate 2 through the suction section and the dust discharge holes 9a is terminated. This is because a sucking force of approximately 2 kPa is exerted on the substrate 2. To terminate the sucking force, it is conceivable to turn off the sucking force generating mechanism (namely, a suction fan) that generates the sucking force every time an attempt to remove the substrate 2 is made. However, even after being turned off, the suction fan continues to run due to its inertial force for a short while (for example, several tens of seconds to several minutes) during which the sucking force remains. As a result, the substrate (pallet) 2 cannot be removed until the suction fan becomes slow enough to produce almost no sucking force, which results in a significant loss of time in manufacturing processes.

### SUMMARY

According to an aspect of the invention, this dust collecting mechanism is a dust collecting mechanism that sucks up and collects dust generated by a machining apparatus, including a suction section for sucking up the dust by exerting sucking force on a workpiece, a sucking force generating mechanism for generating sucking force to be exerted on the suction section, and a suction pipe communicating between the suction section and the sucking force generating mechanism, wherein the suction pipe includes an opening section penetrating through the inside and the outside thereof and a shutter mechanism for opening and closing the opening section, and wherein the pressure inside the suction pipe can be switched between an atmospheric pressure state and an sucking force generating state by causing the shutter mechanism to open or close the opening section while sucking force is generated inside the suction pipe by operating the sucking force generating mechanism.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a substrate cutting apparatus according to an embodiment;

FIG. 2 is a perspective view illustrating structure of a shutter mechanism in a dust collecting mechanism in the substrate cutting apparatus in FIG. 1;

FIG. 3 is a cross-sectional view illustrating the structure of the shutter mechanism in the dust collecting mechanism in the substrate cutting apparatus in FIG. 1;

FIG. 4 is an expanded view illustrating the structure of a coupling section in the shutter mechanism in FIG. 2.

FIG. 5A to 5C are the shutter mechanism of the dust collecting mechanism in the substrate cutting apparatus in FIG. 1.

FIG. 6 is a schematic diagram illustrating an example of a substrate cutting apparatus according to a known embodiment.

### DESCRIPTION OF EMBODIMENTS

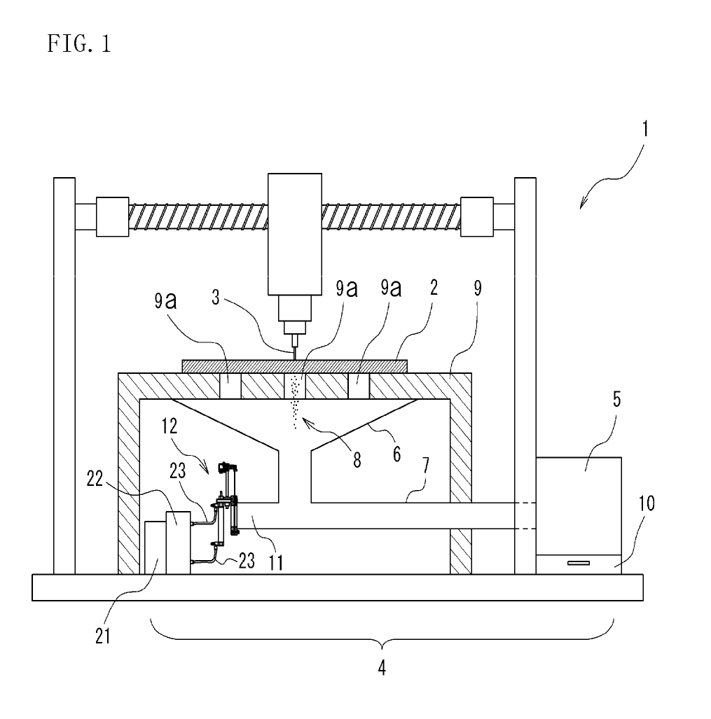

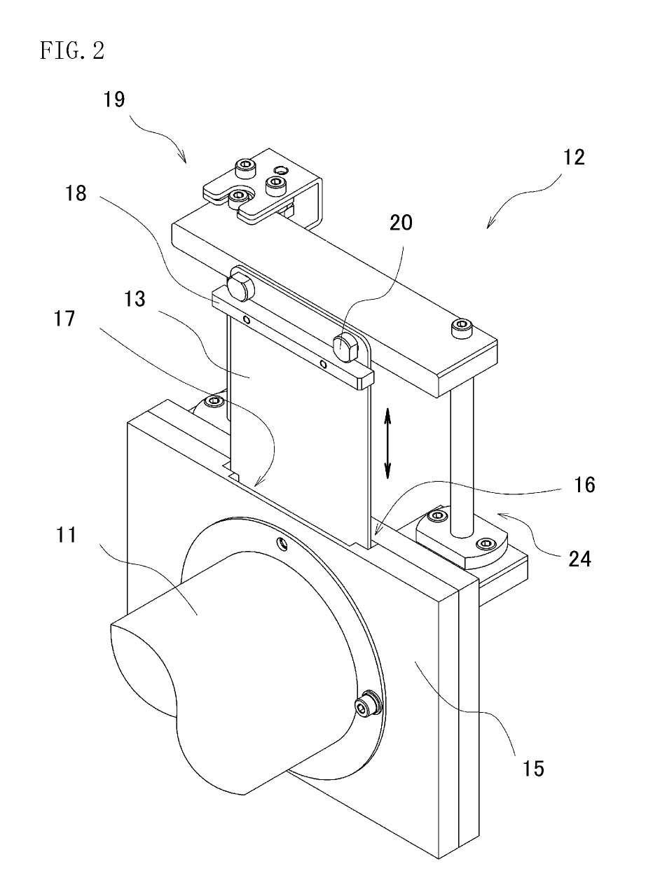

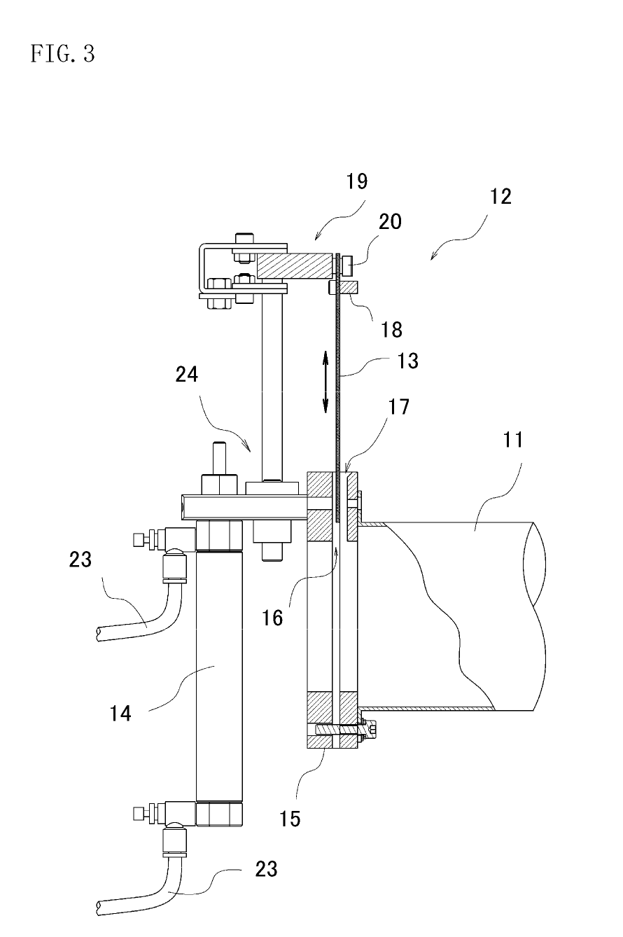

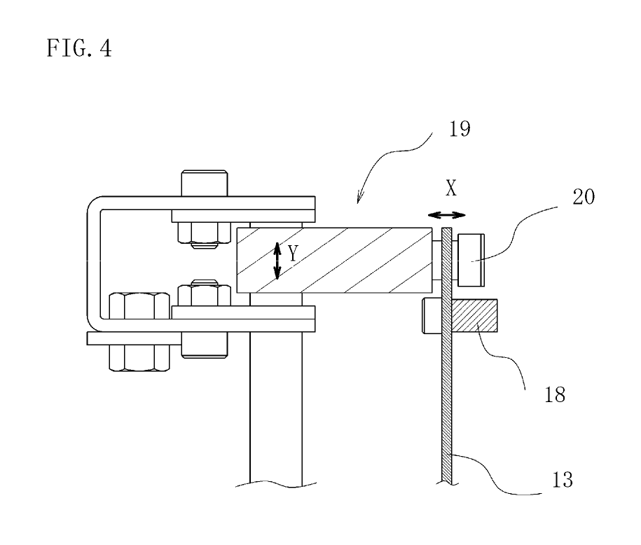

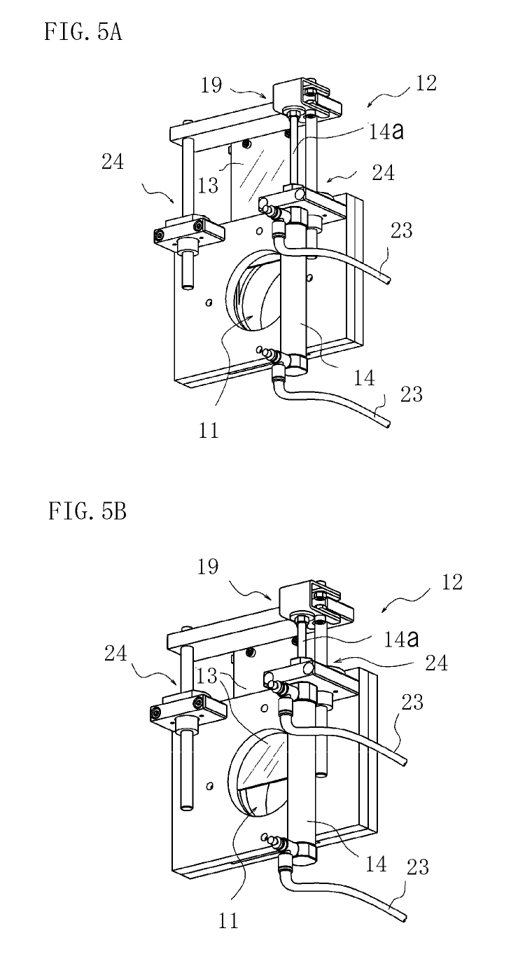

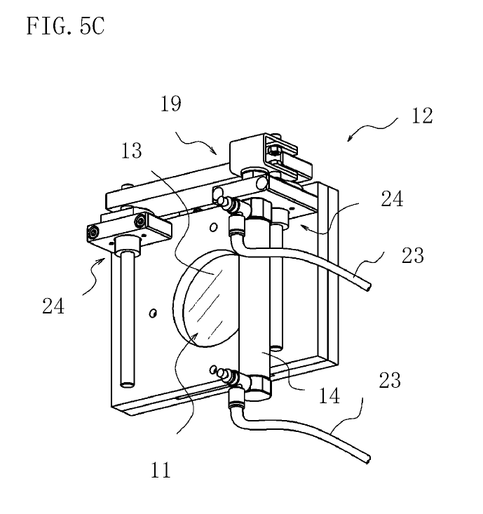

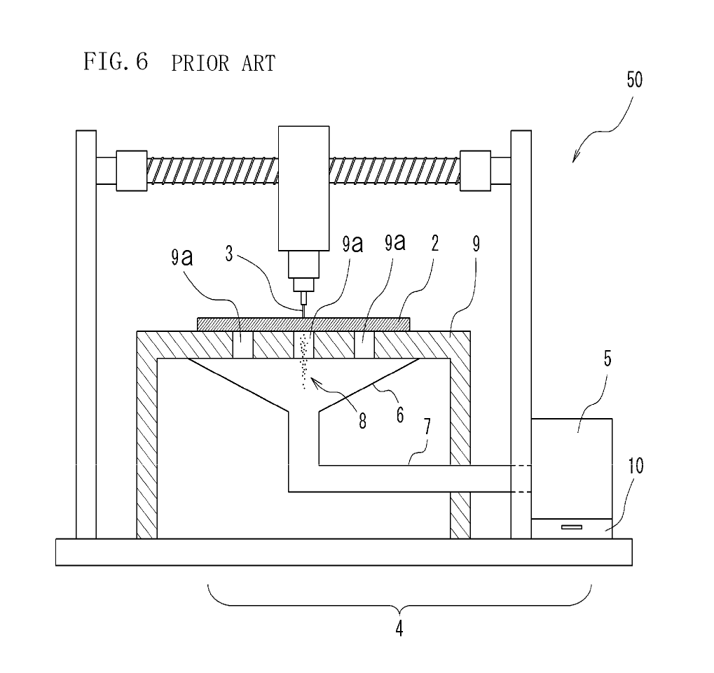

An embodiment will be described below with reference to the accompanying drawings. FIG. 1 is a schematic diagram illustrating an example of a substrate cutting apparatus according to an embodiment. FIG. 2 is a perspective view (schematic diagram) illustrating the structure of the shutter mechanism 12 in a dust collecting mechanism 4 in the substrate cutting apparatus 1. FIG. 3 is a cross-sectional view (schematic diagram) of the shutter mechanism 12, as taken along a plane which is parallel to the direction of sliding of a slide plate 13 and perpendicular to a plate surface of the slide plate 13. FIG. 4 is an expanded view (schematic diagram) illustrating the structure of a coupling section 19 in the shutter mechanism 12. FIGS. 5A, 5B, and 5C are schematic illustrations illustrating the operation of the shutter mechanism 12.

A substrate cutting apparatus 1 according to this embodiment is illustrated in FIG. 1.

The substrate cutting apparatus 1 cuts a planar printed substrate (hereinafter referred to as “substrate”) 2 removably mounted on a fixed unit 9 along predetermined cutting lines with a cutter (router bit) 3 provided thereon so as to be arbitrarily movable in a plane substantially parallel to a workpiece or a substrate 2 and having a blade formed at the edge of a rotating shaft thereof. The substrate cutting apparatus 50 is provided with a dust collecting mechanism 4 for sucking up and collecting the dust (cutting dust) generated on and around the cutting line in the substrate 2. Typically, the substrate 2 is placed on a pallet (not illustrated) and removably mounted on the fixed unit 9 together with the pallet.

The dust collecting mechanism 4 includes a main body 5 having a suction fan (not illustrated) incorporated therein as a sucking force generating mechanism, a tubular suction pipe 7 connected at one end to the main body 5 and provided at the other end with a suction section (a funnel-like duct collection nozzle) 6, and a dust collecting tray 10 for storing the collected dust. The suction section 6 is installed on the back side (opposed to the mounting surface of the substrate 2) of the fixed unit 9.

While a substrate 2 is being cut, dust 8 generated by the cutting is sucked with the activated fan into the suction section 6 through dust discharge holes 9a provided in the fixed unit 9, and sent to the main body 5 through the suction pipe 7. Then the dust 8 is trapped with a filter or the like (not illustrated) before being collected and stored in a dust collection tray 10.

The substrate cutting apparatus 1 according to this embodiment is characterized by an opening section 11 extending from the inside to the outside of the suction pipe 7 as well as a shutter mechanism 12 for opening or closing the opening section 11. As illustrated in FIG. 1, the opening section 11 is formed as a pipe diverging from the suction pipe 7, and the pipe is provided at the end thereof with the shutter mechanism 12. Needless to say, the opening section 11 may be formed directly on the outer wall of the suction pipe 7, and then be provided with the shutter mechanism 12.

The structure of the shutter mechanism 12 will now be described below with reference to the perspective view in FIG. 2 and the cross-sectional view in FIG. 3.

The shutter mechanism 12 according to this embodiment includes a planar slide plate 13 for opening or closing the opening section 11 in a sliding manner and an actuator 14 for sliding the slide plate 13.

More specifically, the opening section 11, namely a pipe diverging from the suction pipe 7 is connected at one end thereof to a main body 15 of the shutter mechanism 12. The main body 15 is provided with a plate penetrating hole 16 through which the slide plate 13 can penetrate. The slide plate 13 slides inside the plate penetrating hole 16 (in the direction indicated by an arrow in FIGS. 2 and 3), thereby opening or closing the opening section 11. The actuator 14 includes, for example, an air cylinder operable at high speed, thereby allowing the slide plate 13 to move at high speed.

As illustrated in FIGS. 1 and 5, in this embodiment, the actuator (air cylinder) 14 is connected to an air pressure generating mechanism 22 via a hose 23. A controller 21 controls air pressure for operating the actuator (air cylinder) 14. For example, to terminate a sucking force for installation or removal of a substrate, the actuator (air cylinder) 14 is caused to project a piston 14a thereof, as illustrated in FIG. 5A, thereby allowing a coupling section 19 and the slide plate 13 coupled with the coupling section 19 to move upward in the direction illustrated in FIG. 5A and open the opening section 11. At this time, the inside of the suction pipe 7 becomes equal to the atmospheric pressure or of an atmospheric pressure state.

Then, to produce a sucking force for substrate cutting (or for dust collecting), the actuator (air cylinder) 14 is caused to retract the piston 14a, as illustrated in FIG. 5A, thereby allowing the coupling section 19 and the slide plate 13 coupled with the coupling section 19 to move downward in the direction illustrated in FIG. 5C and close the opening section 11. At this time, the inside of the suction pipe 7 becomes of a negative pressure to generate a sucking force or a sucking force generating state.

FIG. 5B illustrates a transitional state between FIG. 5A and FIG. 5C.

A numeral 24 depicts a guide section for guiding the coupling section 19 so as to provide a linear motion.

The above structure allows the shutter mechanism 12 to instantly open or close the opening section 11 while the sucking force generating mechanism is operated to generate sucking force inside the suction pipe 7. Accordingly, the pressure inside the suction pipe 7 can be instantly switched between the atmospheric pressure state and the sucking force generating state. In other words, the sucking force exerted on the substrate 2 can be instantly terminated without suspending the sucking force generating mechanism, thereby significantly reducing the time required to install or remove the substrate 2.

It is conceivable to configure the controller 21 to comprehensively perform control of a cutter (router bit) 3 in the substrate cutting apparatus 1, control of carrying in and out of a substrate 2 (pallet), and control of the sucking force generating mechanism in addition to control of the shutter mechanism 12, thereby attaining an automated substrate cutting process.

In contrast, it is conceivable to configure the controller 21 to include a manual operation switch (not illustrated), thereby allowing the shutter mechanism 12 to be manually controlled.

The slide plate 13 is formed of stainless steel because of its high resistance to wear and corrosion. The plate penetrating hole 16 is designed so as to penetrate through the main body 15, in order to prevent faulty operation due to the accumulation of dust 8.

The shutter mechanism 12 may use various types of structures for opening or closing the opening section 11, other than the slide plate type above, such as a butterfly valve or the like.

Since a sucking force of approximately 2 kPa acts on the inside of the suction pipe 7 or the opening section 11, as described above, the slide plate 13 of the shutter mechanism 12 is in strong sliding contact with the main body (plate penetrating hole 16) while moving in a sliding manner, which poses the problem of wear.

In order to solve the problem, an auxiliary opening 17 extending from the inside to the outside of the suction pipe 7 as well as an auxiliary lid 18 for opening or closing the auxiliary opening 17, which characterizes this embodiment, is provided in the suction pipe 7 at a position subject to a pressure change resulting from the opening or closing of the opening section 11.

More specifically, as illustrated in FIGS. 2 and 3, the auxiliary opening 17 is provided in a pipe diverging from the suction pipe 7 and constituting the opening section 11 at a position closer to a sucking force generating source than the plate penetrating hole 16. In this embodiment, the auxiliary opening 17 is a hole that opens in the direction parallel to the direction of sliding of the slide plate 13 and has no partition with the plate penetrating hole 16 to simplify structure and manufacture. The auxiliary lid 18 is formed on the slide plate 13 so as to stand at right angles to the surface of the slide plate 13, and disposed in such a manner that the auxiliary lid 18 fully closes the auxiliary opening 17 when the slide plate 13 slides to fully close the opening section 11. The auxiliary lid 18 may be secured to the actuator 14.

With this arrangement, when the slide plate 13 begins to slide to cause the opening section 11 to move toward an opened state from a fully closed state, the auxiliary opening 17 is switched to an opened state. In other words, when the slide plate 13 slightly slides toward the opened state from the fully closed state, the auxiliary opening 17 completes a switch to the opened state.

With this arrangement, until immediately before the slide plate 13 slides to cause the opened opening section 11 to be fully closed, or immediately after slide plate 13 begins to slide to cause the fully closed opening section 11 to be opened, the sucking force exerted on the inside of the suction pipe 7 decreases due to the opened auxiliary opening 17, thereby preventing wear resulting from the sliding motion of the slide plate 13. The fully closed opening section 11 causes the auxiliary lid 18 to fully close the auxiliary opening 17, providing air tightness which allows the sucking force inside the suction pipe 7 to act on the substrate 2. No limitations are placed on the opening area of the auxiliary opening 17. However, if the auxiliary opening 17 has a greater opening area than the opening section 11, only the auxiliary opening 17 suffices for purposes described above, which eliminates the necessity for the opening section 11. Taking into consideration the fact that the auxiliary opening 17 is a component for creating the above effect, it is preferable that the auxiliary opening 17 is formed to have a smaller opening area than the opening section 11. This eliminates the necessity for the actuator 14 to have more power than required, leading to a reduction in size of the apparatus and a reduction in part cost.

In addition, as illustrated in FIG. 4, the slide plate 13 is mounted on the coupling section 19 of the actuator 14 so as to be slightly movable (several millimeters) in the direction (indicated by an arrow “X” in FIG. 4) perpendicular to the surface of the slide plate 13.

More specifically, as illustrated in FIG. 4, the slide plate 13 is formed to have a threaded hole slightly larger in diameter than the thread of a mounting screw 20, and the mounting screw 20 is designed to be secured to the coupling section 19 such that its head is several millimeters away from the coupling section 19, thereby allowing the slide plate 13 to move in the direction indicated by an arrow “X” in FIG. 4. Furthermore, the plate penetrating hole 16 is formed to have a larger width (width in the direction perpendicular to the plane of the slide plate) than the thickness (thickness in the direction perpendicular to the plane of the slide plate) of the slide plate 13, thereby allowing the slide plate to move.

This arrangement allows the slide plate 13 to smoothly slide to open/close the opening section 11 and also strengthens its contact with the opening section 11, namely adhesion to the open end of the opening section 11 in the plate penetrating hole 16.

Furthermore, in this embodiment the slide plate 13 is slightly movable (several millimeters) in the direction (indicated by an arrow “Y” in FIG. 4) of sliding thereof, thereby further enhancing the above effect.

As described above, a dust collecting mechanism according to this embodiment and the substrate cutting apparatus 1 provided with the same can instantly switch between the atmospheric pressure state and the sucking force generating state, the sucking force or the pressure inside a suction pipe to be exerted on the substrate 2 for collecting dust (cutting dust) generated at the time of cutting the substrate 2. Accordingly, the substrate cutting apparatus 1 can instantly terminate the sucking force acting on the substrate 2 for installation or removal of the substrate 2 without suspending the sucking force generating mechanism, thereby significantly reducing the time required to install or remove the substrate 2.

Also, the substrate cutting apparatus 1 can solve the problem of wear resulting from sliding in the shutter mechanism since it can provide the above-described effect without suspending the sucking force generating mechanism.

The substrate cutting apparatus 1 for cutting a composite printed substrate into a plurality of printed substrates is described above as one embodiment. However, needless to say, in addition to such an apparatus, the present technique can be applied to a dust collection mechanism for collecting and storing dust (cutting dust) generated by a machining apparatus for cutting resin or metallic materials.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A dust collecting mechanism for sucking up and collecting dust generated by a machining apparatus, comprising:
a suction section for sucking up the dust by exerting a sucking force on a workpiece;
a sucking force generating mechanism for generating the sucking force acting on the suction section; and
a suction pipe for enabling communication between the suction section and the sucking force generating mechanism, the suction pipe including
an opening section for extending from the inside of the suction pipe to the outside of the suction pipe, and
a shutter mechanism for opening or closing the opening section, wherein pressure inside the suction pipe can be switched between an atmospheric pressure state and a sucking force generating state by causing the shutter mechanism to open or close the opening section while the sucking force is generated inside the suction pipe by operating the sucking force generating mechanism.

2. The dust collecting mechanism according to claim 1,
wherein the shutter mechanism includes a planar slide plate for opening or closing the opening section in a sliding manner and an actuator for sliding the slide plate.

3. The dust collecting mechanism according to claim 2,
wherein an auxiliary opening extending from the inside to the outside of the suction pipe is provided in the suction pipe at a position subject to a pressure change resulting from opening or closing of the opening section, the auxiliary opening having a smaller opening area than the opening section;
wherein an auxiliary lid secured to the slide plate or the actuator fully closes the auxiliary opening when the slide plate fully closes the opening section; and
wherein when the slide plate begins to slide to cause the opening section to move toward an opened state from a fully closed state, the auxiliary opening is switched to an opened state.

4. The dust collecting mechanism according to claim 2,
wherein the slide plate is movable at least in the direction perpendicular to a plate surface thereof and is secured to a coupling section of the actuator so as to open or close the opening section with the plate surface thereof.

5. The dust collecting mechanism according to claim 3,
wherein the slide plate is movable at least in the direction perpendicular to a plate surface thereof and is secured to a coupling section of the actuator so as to open or close the opening section with the plate surface thereof.

6. A substrate cutting apparatus for cutting a substrate as a workpiece, comprising:
a dust collecting mechanism according to claims 1,
a fixed unit for securing the substrate, and
a cutter for cutting the substrate.

7. The substrate cutting apparatus according to claim 6,
wherein the shutter mechanism includes a planar slide plate for opening or closing the opening section in a sliding manner and an actuator for sliding the slide plate.

8. The substrate cutting apparatus according to claim 7,
wherein an auxiliary opening extending from the inside to the outside of the suction pipe is provided in the suction pipe at a position subject to a pressure change resulting from opening or closing of the opening section, the auxiliary opening having a smaller opening area than the opening section;
wherein an auxiliary lid secured to the slide plate or the actuator fully closes the auxiliary opening when the slide plate fully closes the opening section; and
wherein when the slide plate begins to slide to cause the opening section to move toward an opened state from a fully closed state, the auxiliary opening is switched to an opened state.

9. The substrate cutting apparatus according to claim 7,
wherein the slide plate is movable at least in the direction perpendicular to a plate surface thereof and is secured to a coupling section of the actuator so as to open or close the opening section with the plate surface thereof.

10. The substrate cutting apparatus according to claim 8,
wherein the slide plate is movable at least in the direction perpendicular to a plate surface thereof and is secured to a coupling section of the actuator so as to open or close the opening section with the plate surface thereof.

11. The substrate cutting apparatus according to claim 6,
wherein the sucking force exerted by the suction section on the substrate is reduced or terminated when the opening section is opened by the shutter mechanism while the sucking force is generated inside the suction section.

12. The substrate cutting apparatus according to claim 7,
wherein the sucking force exerted by the suction section on the substrate is reduced or terminated when the opening section is opened by the shutter mechanism while the sucking force is generated inside the suction section.

13. The substrate cutting apparatus according to claim 8,
wherein the sucking force exerted by the suction section on the substrate is reduced or terminated when the opening section is opened by the shutter mechanism while the sucking force is generated inside the suction section.

14. The substrate cutting apparatus according to claim 9,
wherein the sucking force exerted by the suction section on the substrate is reduced or terminated when the opening section is opened by the shutter mechanism while the sucking force is generated inside the suction section.

15. The substrate cutting apparatus according to claim 10,
wherein the sucking force exerted by the suction section on the substrate is reduced or terminated when the opening section is opened by the shutter mechanism while the sucking force is generated inside the suction section.
